(19) United States
(12) Patent Application Publication
(10) Pub. No.: US 2004/0112166 A1
(43) Pub. Date: Jun. 17, 2004

(54) Bicycle cable brake line

(76) Inventor: Jon Richardson, Winter Haven, FL (US)

Correspondence Address: Charles H. Thomas, CISLO & THOMAS LLP, 4201 Long Beach Blvd., Suite 405, Long Beach, CA, 90807-2022, US

(21) Appl. No.: 10/318,554

(22) Filed: Dec. 13, 2002

(51) Int. Cl. F16C 1/10

(52) U.S. Cl. 74/500.5

(57) ABSTRACT

A single rear bicycle brake operating cable core is employed to operate the rear brake of a freestyle bicycle that employs a rotatable coupler that allows the handlebars, front wheel, and front wheel fork of a bicycle to be rotated through a complete revolution about the axis of the head tube of the bicycle frame. Instead of employing a pair of rear brake cable cores that are terminated individually at the lever arm ends of a pair of rear bicycle brake calipers, a single rear brake operating cable core is provided. Both ends of this single operating cable core are terminated not at the brake calipers, but rather to the nonrotatable portion of the rotatable coupling. The single brake cable core is looped about rollers or pulleys attached to the lever arm ends of both of the brake calipers so that the cable brake arm contact points at the brake calipers are not fixed. Since there is a single brake cable line passing through floating roller points of contact, the system is self-balancing. Thus, tension on the cable line allows the gyroscopic system to self-adjust the balance of its bearing unit. As a result, the bicycle brake cable system of the invention avoids common rotational “flop” of the rotatable coupler when the handlebars and front wheel are rotated relative to the bicycle frame.

### BACKGROUND OF THE INVENTION

1. Field of the Invention

The present invention relates to a bicycle brake cable system operated by a brake control lever mounted on a bicycle handlebar in a bicycle in which the handlebars and front wheel of the bicycle are freely rotatable relative to the bicycle frame.

2. Description of the Prior Art

A conventional bicycle employs a frame upon which the seat, rear wheel, pedals, and chain drive transmission mechanism are mounted, and a steering assembly rotatably mounted relative to the frame. The major components of a bicycle steering assembly include a front wheel, a front wheel fork, a steering tube, a handlebar stem, and a set of handlebars. The steering assembly can be turned at an angle relative to the frame about an axis of rotation extending along the center of the steering tube of the steering assembly and the center of the head tube of the frame. The steering tube is mounting coaxially within the head tube and turns relative thereto on steering bearings interposed therebetween.

A number of years ago rotatable brake cable coupling systems were devised for use on a bicycle which allowed a rider to completely rotate the steering assembly of a bicycle as a unit relative to the bicycle frame on a bicycle having hand brakes. Prior to this time such a manipulation was not possible since the bicycle brake cables extending from the hand brake controls on the handlebars to the brake calipers of the brakes on the front and rear wheels of a bicycle would permit only limited rotation of the steering assembly relative to the frame to an arc of far less than 360 degrees.

However, a rotatable brake cable coupling system allows the front wheel, front wheel fork, steering tube, and handlebars of a bicycle to be rotated together through repeated 360-degree revolutions relative to the bicycle head tube and bicycle frame. This feature allows riders to perform stunts while only the rear wheel of the bicycle is in contact with the riding surface or while only the front wheel is in contact with the riding surface. A bicycle having this capability is known in the bicycle industry as a “free-style” bicycle and the rotatable coupling is often referred to as a cable “detangler”.

One embodiment of a rotatable brake cable coupling system is described in U.S. Pat. No. 084,322 issued in the Republic of China (Taiwan). Such a rotatable brake coupling system is sold commercially as the Gyro rotatable brake coupling system by Bear Corporation located at 16325 Arthur Street, Cerritos, Calif. 90703.

In a conventional rotatable brake cable coupling system the rear brake cable is divided into two segments, namely a lower operating segment and an upper control segment. The lower operating segment has a single brake operating end termination and a pair of control coupling end terminations. The single brake operating end termination is secured to the rear brake. Specifically, the cable sheath is secured to one of the brake calipers and the cable core that moves in reciprocation within the sheath extends onto and is terminated at the other brake caliper.

The pair of control coupling end terminations extend from a junction on the frame and up the outside of the head tube at the front of the frame to a lower cable stop. The lower cable stop is formed with a pair of diametrically opposed brake cable termination ears that are fixed relative to the bicycle frame head tube and rotatable relative to the front wheel assembly. The cable sheaths of the control coupling end terminations of the lower, operating segment of the rear brake cable are secured to the bicycle head tube by means of connections to the brake cable termination ears while the control coupling end terminations of the rear brake cable operating segment core elements extend upwardly from the sheath terminations and are connected to the portion of an annular rotor that is nonrotatable relative to the head tube and rotatable relative to the front wheel steering assembly.

The upper or control segment of the rear brake cable likewise has a single brake control end termination that is connected to a rear hand brake control mounted on one of the handlebars of the bicycle. The upper, control segment of the rear brake cable extends downwardly from the handlebars and terminates in a pair of operating end coupling terminations. The control segment sheath elements of the upper or control segment of the rear brake cable are fastened to a pair of diametrically opposed upper brake cable termination ears that are secured to the steering tube of the bicycle. The core member components of the upper, control segment of the rear brake cable extend downwardly past the terminations of the sheath members in which they are disposed and are secured to the portion of the brake cable coupling system rotor that is nonrotatable relative to the front wheel steering assembly and rotatable relative to the bicycle frame.

In the brake cable coupling system rotor there are components which are rotatable relative to each other. To distinguish these components from each other the portion which is constrained from rotation relative to the front wheel steering assembly is hereinafter referred to as “rotatable”, while the portion that is constrained from rotation relative to the bicycle head tube and the bicycle frame is referred to as “nonrotatable”.

The rotor coupling includes a bearing race between its nonrotatable and rotatable portions in which a number of ball bearings are arranged in an annular ring about the head tube of the bicycle frame. The rotatable portion of the rotor turns in rotation with the steering tube but can move in longitudinal reciprocation relative thereto. The rotatable portion of the rotor is carried in rotation with the steering tube by virtue of the connection of the cable sheath operating end coupling terminations of the upper cable control segment to the upper brake cable termination ears and by the connection of the core elements of the cable control segment to the rotatable portion of the rotor. The control coupling end terminations of the operating segment are prevented from rotating relative to the head tube by virtue of the connection of the sheath elements thereof to the lower fixed brake cable termination ears and the connection of the core elements thereof to the nonrotatable rotor portion. However, the nonrotatable portion of the rotor can move in longitudinal reciprocation relative to the head tube.

The operation of the hand brake lever mounted on the bicycle handlebar that controls the rear wheel brake places tension on the inextensible core elements of the cable control segment of the rear brake cable. This draws both the rotatable and nonrotatable portions of the rotor upwardly toward the handlebars in longitudinal movement relative to both the steering tube and the head tube. Since the nonrotatable portion of the rotor is coupled to the rotatable portion thereof through the overhanging arrangement of the bearing races, the entire rotor assembly is drawn upwardly. This transmits the tensile force from the core elements of the upper, cable control segment of the rear brake cable to the core elements of the lower, operating segment of the rear brake cable. This tensile force in turn operates the calipers of the rear brake.

Prior brake cable systems of this type have certain disadvantages. Specifically, the cable couplings of the dual cables on either side of both the rotatable and nonrotatable portions of the rotor must be independently adjustable and must be closely balanced relative to each other. If they are not, the rotor assembly will tilt out of perpendicular alignment relative to the stem of the bicycle fork when the brakes are applied. This is known as cable “flop”.

### SUMMARY OF THE INVENTION

According to the present invention, a single brake cable core loop is employed below the “gyro” rotor coupler. Instead of being terminated at one of the brake calipers, this single, inextensible cable loop is looped about rollers in the form of pulleys attached to both of the brake calipers. The pulley attachments at the rear brake lever arms allow the operating segment of the lower brake cable to be set up with a single length of cable core rather than the conventional “two-in-one” or two cable configuration. The brake cable core of the operating segment of the brake cable is secured at both of its ends to the annular lower coupling plate. Since there is a single brake cable core line passing through floating roller points, the system is self-balancing. The contact points on the operating cable core loop with the brake calipers are not fixed. Thus, tension on the cable line allows the gyroscopic system to self-adjust and equalize longitudinal forces on both sides of the rotor coupling. This design decreases common rotational “flop” when turning the handlebars that is caused by poorly tensioned conventional “fixed” cable set-ups.

Similarly, the upper, control segment of the brake cable system preferably employs a single brake cable core rather than a pair of cable core portions. The single control brake cable core is terminated at one end to one side of the upper annular rotor coupling plate and extends through a section of cable sheath. The single control brake cable core is turned 180° about a turning pulley and directed through another section of cable sheath. The other end of the cable core is coupled to the opposing side of the annular upper rotor coupling plate. A coupling link is connected between the turning pulley and the brake lever handle. Thus, the turning pulley rotates so that equal tension is exerted along the two portions of the control brake cable core, thereby balancing the lifting forces applied to the annular, upper rotor coupling plate.

The floating force application pulleys of both the upper and lower cables thereby equalize tension applied to the ends of both the rear brake cable cores, which are coupled to opposing sides of their respective coupling plates. The equalization of forces on the coupling plates keeps them from “flopping”.

In one broad aspect the present invention may be considered to be a bicycle brake cable system for operating a pair of opposing bicycle brake calipers from a handlebar-mounted brake lever and including a rotatable coupling enabling free spinning of a bicycle handlebar and front wheel assembly relative to an associated bicycle frame. The bicycle brake cable system of the invention includes a brake control segment extending between the brake lever and the rotatable coupling, and a brake operating segment extending between the rotatable coupling and the brake calipers.

According to the improvement of the invention the brake cable operating segment is comprised of a single, inextensible lower cable core loop having opposing ends. Both of the ends of the cable core loop terminate at the rotatable coupling. Each of the opposing calipers has a cable-engaging lever arm end. The single lower cable core loop is looped about both of the cable-engaging lever arm ends and is movable relative thereto.

The brake lever arm ends can be constructed as simple, fixed turning posts across which the cable core loop slides. However, such a system would create excessive wear on the cable core loop and/or on the turning posts due to frictional abrasion resulting from the sliding contact between the cable core loop and the turning posts.

To reduce frictional abrasion separate rollers in the form of pulleys are preferably provided, one mounted on each of the caliper lever arm ends. The rollers rotate independently of each other to accommodate longitudinal shifting of the lower cable core loop relative thereto. As a consequence, the lower cable core loop pulls evenly on both sides of the nonrotatable portion of the rotatable coupling since any inequality in force of application of the brake pads to the bicycle tire causes the roller on the lever arm with the lightest force applied thereto to rotate until the force on the two calipers is equal. This self-compensation occurs instantaneously, thereby avoiding cable flop. The tension on the lower cable core causes the pulleys to rotate independently of each other to equalize force transmitted to the brake calipers and to the rotatable coupling.

The invention may also be considered to be an improvement in a bicycle brake cable system for operating rear wheel brake calipers on a bicycle having handlebars, a front wheel steering tube, and a front wheel fork mounted together for free spinning rotation relative to a bicycle frame head tube. A cable detangler is employed having a nonrotatable collar and a rotatable collar mounted for rotation relative to the nonrotatable collar. The rotatable collar and the nonrotatable collar are longitudinally reciprocal relative to the head tube.

According to the improvement of the invention a single, inextensible brake operating cable core loop is provided having opposing ends. Both of the ends of the single brake operating cable core loop are joined to the nonrotatable collar. A separate lever arm is provided on each of the rear wheel brake calipers. The brake operating cable core loop is engaged with both the rear wheel brake caliper lever arms for movement in reciprocal, traveling relationship therewith. In the preferred embodiment, each lever arm is provided with a separate pulley and the brake operating cable core loop is looped through and passes about both of the pulleys.

In still another aspect the invention may be considered to be an improvement in a bicycle brake cable system for the rear wheel mounted within a rear wheel fork of a bicycle which has bicycle handlebars, a handlebar mounting stem, a steering tube, and a front wheel fork all mounted for fee spinning rotation relative to a bicycle frame head tube. A cable detangler mechanism is employed in such a bicycle brake cable system. The cable detangler mechanism acts between the steering tube and the head tube. A pair of cooperating brake calipers are mounted on the rear wheel fork. The brake calipers have lever arm ends and opposing brake pad ends carrying brake pads thereon. The cooperating brake calipers are mounted on opposing sides of the rear wheel fork to apply braking force against the rear wheel.

According to the improvement of the invention a single, inextensible, brake operating cable core having opposing ends is provided. Both of the brake operating cable core ends terminate at the cable detangler mechanism. The brake operating cable core is formed into a single loop that is engaged at floating contact locations with both of the lever arm ends of the pair of cooperating rear brake calipers. Separate pulleys are preferably provided on each of the lever arm ends. The single brake operating cable core loop is passed about both of the pulleys. The pulleys rotate independently of each other in response to movement of the floating contact locations of the loop.

The invention may be described with greater clarity and particularity by reference to the accompanying drawings.

### DESCRIPTION OF THE DRAWINGS

FIG. 1 is a perspective view of a bicycle that incorporates the improved bicycle brake cable system of the invention.

FIG. 2 is a rear elevational, diagrammatic view of the bicycle brake cable system of the invention employed on the bicycle shown in FIG. 1.

FIG. 3 is a rear elevational detail illustrating equalization of force to both ends of the lower rear brake operating cable core loop when a stronger braking force is initially applied to the left-hand brake pad illustrated.

FIG. 4 is a rear elevational detail illustrating equalization of force to both ends of the lower rear brake operating cable core loop when a stronger braking force is initially applied to the right-hand brake pad illustrated.

### DESCRIPTION OF THE EMBODIMENT

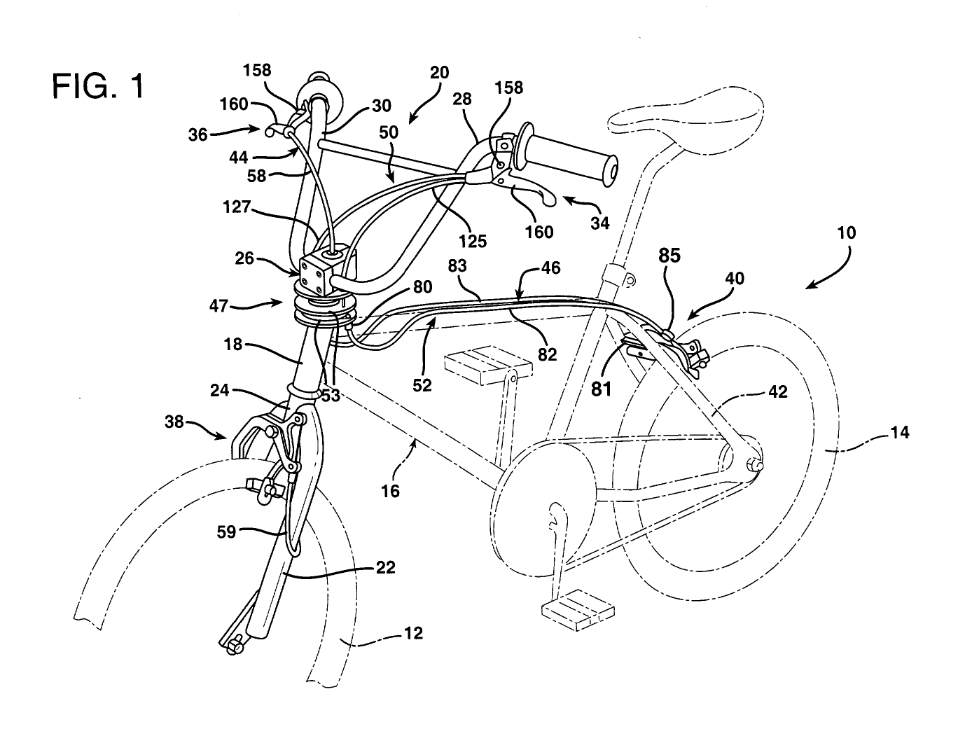

FIG. 1 illustrates a bicycle 10 having the usual front wheel 12 and real wheel 14 which support a rigid, tubular steel or aluminum frame 16. The frame 16 is equipped with a hollow, cylindrical, annular bicycle frame head tube 18 at its forward end and a rear wheel fork 42 at its rear end.

The bicycle 10, like all bicycles, includes a front wheel steering assembly indicated generally at 20. The front wheel steering assembly 20 includes the front wheel 12, a front wheel fork 22, a steering tube 24, a handlebar stem 26, and a set of handlebars 28 and 30. The steering tube 24 is located atop the front wheel fork 22 and projects upwardly through the head tube 18 of the frame 16. The upper portion of the steering tube 24 that protrudes into the head tube 18 is captured within the grip of the stem 26. The stem 26 also carries the handle bars 28 and 30.

A rear wheel brake control 34 and a front wheel brake control 36 are respectively mounted on the handlebars 28 and 30 in the handlebar set. The bicycle 10 also includes a front wheel brake 38 and a rear wheel brake 40. The front wheel brake 38 is mounted on the front wheel fork 22, while the rear wheel brake 40 is mounted on the rear wheel fork 42. A front brake cable 44 and a rear brake cable 46 lead respectively from the front and rear brake controls 36 and 34 to the front and rear wheel brakes 38 and 40.

A rotatable brake cable coupling system 47 is mounted on the bicycle 10 and is interposed between the head tube 18 and the steering tube 24. The rotatable brake cable coupling system 47 and the front brake cable 44 are illustrated and described in detail in prior U.S. Pat. No. 5,791,671, which is hereby incorporated herein by reference in its entirety. The rotatable brake cable coupling system 47 includes a rotor assembly that divides the rear brake cable 46 into a control segment 50 that is secured to the rear brake control 34 and to the handlebar 28 and an operating segment 52 that is secured to the bicycle frame 16 and to the rear wheel brake 40.

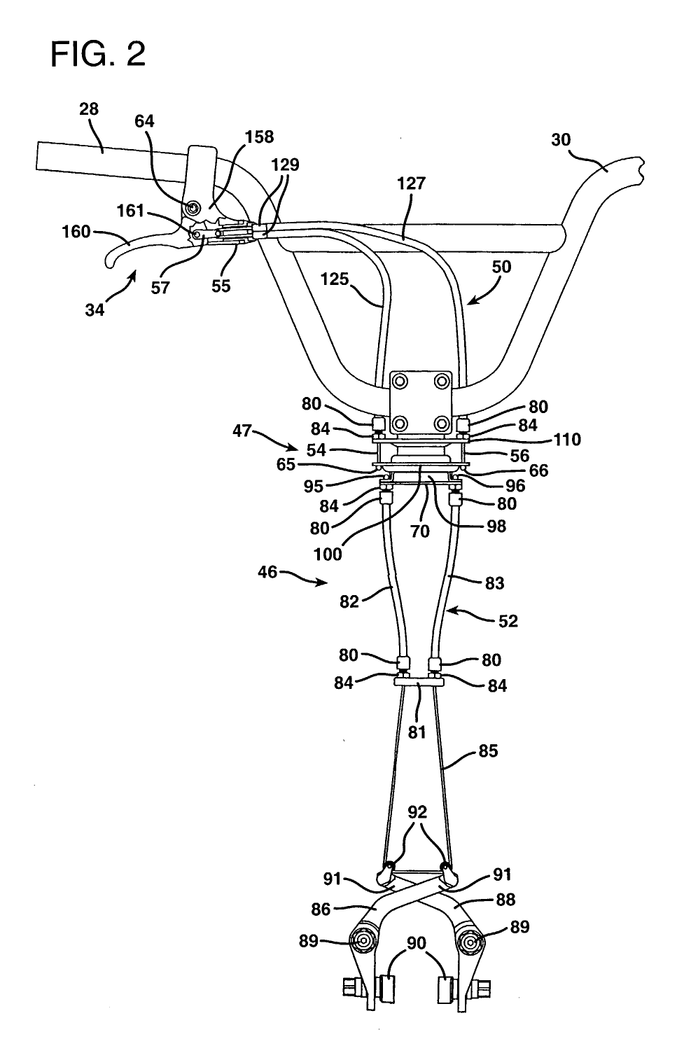

The rear brake operating control 34 is mounted on the handlebar 28. The rear brake operating control 34 is a conventional bicycle hand brake control and is illustrated in FIG. 2. The rear brake operating control 34 includes a rear brake control stationary body member 158 that is secured to the handlebar 28 and a rear brake control engagement lever 160 that is mounted for rotational movement relative to the rear brake control stationary body member 158.

The operating components of the rotatable brake cable coupling system 47 that interact with the components of the rear brake cable 46 are illustrated diagrammatically in FIG. 2. The upper control segment 50 of the rear brake cable 46 is formed of a single, inextensible rear brake control cable core loop 55 that is looped about a pulley located between the side plates of a toggle link 57. The toggle link 57 in turn is joined to the rear brake lever 160 by a rotatable connection 161. As the rear brake lever 160 is drawn closer to the handlebar 28, tension is exerted through the link 57 on the upper cable core 55 to draw lower extremities 54 and 56 of the upper cable core loop 55 upwardly.

As illustrated in FIG. 1, the front brake cable 44 includes an upper, plastic, tubular sheathed section 58 and a lower, plastic, tubular sheathed section 59 that are disposed coaxially about a front wheel brake cable core formed of an inextensible material, such as a plurality of twisted stainless steel wires. At least the core of the front brake cable 44 is routed through a longitudinal passageway formed through the hollow, threadless steering tube 24 and extends from the front brake control 36 to the front wheel brake 38.

The handlebars 28 and 30, the front wheel mounting stem 24, and the front wheel fork 22 are all mounted together for free spinning rotation relative to the bicycle frame head tube 18 and relative to the bicycle frame 16. With the routing of the front brake cable 44 and the provision of a rotatable brake cable coupling system 47, the steering assembly 20, the rear brake cable control segment 50, and the front brake cable 44 are freely rotatable together relative to the head tube 18 and relative to the rear brake cable operating segment 52.

As shown diagrammatically in FIG. 2, a pair of diametrically opposed, lower, nonrotatable brake cable termination ears project radially outwardly from a lower cable stop plate 70 that resides in abutment against the upper edge of the bicycle frame head tube 18. The lower cable stop plate 70 is held immobilized relative to the head tube 18. The ears that project outwardly from the lower cable stop plate 70 have longitudinal, internally threaded openings defined therethrough.

The rotatable brake cable coupling system 47 is a cable detangler that has a both a nonrotatable rotationally immobilized connection collar 98 and a collar 100 mounted for free rotation relative to the nonrotatable collar 98. The nonrotatable collar 98 is formed as an annular structure that has an inner periphery that extends from beneath the rotatable collar 100 upwardly through a central axial opening in the rotatable collar 100 to form an upper rotor bearing race, as described in U.S. Pat. No. 5,791,671. The upper extremity of the inner periphery of the nonrotatable collar 98 is turned radially outwardly at its upper extremity to overhang the radially inner portion of the structure of the rotatable collar 100.

The rotatable brake cable coupling system 47 is provided with a thrust washer atop which an upper cable stop 110 is seated. The upper cable stop 110 is provided with a pair of diametrically opposed, radially projecting ears through which internally tapped openings are formed. Upper control cable sheath sections 125 and 127 are formed of stiff, but bendable plastic. The upper ends of the plastic cable sheath sections 125 and 127 are secured to the brake control body 158 at brake lever terminations 129. The lower ends of the cable sheath sections 125 and 127 terminate in coupling end terminations that have nipples engaged in the threaded apertures of the ears of the upper cable stop 110. The extremities 54 and 56 of the rear cable control core 55 extend downwardly through the cable sheath sections 125 and 127 and through the ears of the cable stop 110 and are secured by means of knobs 65 and 66 on diametrically opposed sides of the rotatable collar 100 of the rotatable brake cable coupling system 47.

The lower rear cable operating segment 52 of the brake cable system of the invention is formed with a pair of hollow, plastic operating segment cable sheath sections 82 and 83. The operating segment cable sheath sections 82 and 83 are formed of a stiff, but bendable plastic. The cable sheath sections 82 and 83 are secured to the bicycle frame 16 periodically at intervals between the rotatable brake cable coupling system 47 and the rear wheel bicycle brake fork 42 so that very little lateral flexure of the operating segment brake cable sheath sections 82 and 83 can occur. The cable sheath sections 82 and 83 both have upper, forward ends that terminate at a pair of control coupling end terminations 80 on diametrically opposite sides of the lower cable stop plate 70. The stop plate 70 has a pair of ears that project diametrically outwardly with longitudinally, internally threaded openings defined therethrough. The control coupling end terminations 80 both have upwardly directed nipples that are threaded into the openings in the stop plate 70. Adjusting nuts 84 are threadably engaged externally upon the threaded nipples at the control coupling end terminations 80 and bear against the underside of the stop plate 70.

The lower, rear ends of the operating segment cable sheath sections 82 and 83 likewise terminate in coupling end terminations 80 that are secured to a stop bar 81 that is anchored to the bicycle frame 16 proximate the rear wheel bicycle fork 42 just forward of the rear brake 40. The end coupling terminations 80 at the rear ends of the cable sheath sections 82 and 83 are threadably engaged in the stop bar 81 with adjusting nuts 84 in the same manner as previously described with respect to the upper, forward ends of the operating segment cable sheath sections 82 and 83.

A novel and very important aspect of the bicycle brake cable system of the invention is the use of a single, inextensible rear brake cable core loop 85. In the embodiment shown the loop 85 has opposing ends that terminate in lower segment coupling end termination knobs 95 and 96. The cable sheath sections 82 and 83 are disposed about the portions of the two ends of the rear cable core loop 85 that extend between the rear stop bar 81 and the lower stop plate 70. Both of the end extremities of the single cable core loop 85 are joined by the knobs 95 and 96 to the nonrotatable collar 98.

The rear brake 40 is comprised of a pair of brake calipers 86 and 88. Both of the brake calipers 86 and 88 are hinged for rotation about brake caliper mounting posts 89 that are anchored on opposing sides of the rear bicycle wheel fork 42. Each of the brake calipers has a brake pad end upon which a brake pad 90 is mounted and an opposing cable-engaging lever arm end 91 at which a roller in the form of a pulley 92 is mounted. The single lower cable core loop 85 is looped about both the cable-engaging lever arm ends 91, since it is looped over both of the pulleys 92.

The rear brake 40 operates in the following manner. When the brake lever 160 is squeezed toward the handlebar 28 and rotates relative to the stationary brake control lever body member 158, tension is exerted on the single, cable core loop 55 in the upper, control segment 50 of the rear brake cable 46 through the link 57. Ideally, tension is exerted equally on both of the cable core ends 54 and 56, thereby drawing the rotatable plate 100 of the detangler or rotatable brake cable coupling system 47 upwardly, longitudinally relative to the bicycle frame head tube 18. The upward movement of the rotatable plate 100 likewise pulls the nonrotatable plate 98 upwardly, thereby pulling the single cable core loop 85 of the operating segment 52 of the rear brake cable 46 away from the rear bicycle wheel 14. The tension on the ends of the rear brake cable core loop 85 that terminate in the knobs 95 and 96 is transmitted to the lever arm ends 91 of the pair of cooperating brake calipers 86 and 88. This force pulls the lever arm ends 91 of the brake calipers 86 and 88 toward each other, thereby rotating the brake calipers 86 and 88 and bringing the brake pads 90 to bear against the sides of the rear wheel 14 located therebetween.

If the rear brake 40 is perfectly adjusted, and if the end coupling terminations 80 and the adjusting nuts 84 are likewise perfectly adjusted, the cable detangler mechanism 47 will remain in perfect perpendicular alignment relative to the bicycle head tube 18. More typically, however, there will be some slight variation in force applied to the cable core ends and transmitted along the length of the lower cable loop 85 of the rear brake operating cable segment 52. In a conventional bicycle brake cable coupling system for the rear wheel of the bicycle 10 employing a detangler mechanism 47, this inequality in force will result in tilting or “flop” of the cable detangler 47, causing it to move out of perpendicular alignment relative to the head tube 18. However, by employing the single cable core loop 85 in the rear brake cable operating segment 52 in such a manner that the cable loop 85 is movable relative to the lever arm ends 91, there is an automatic compensation for any force inequality.

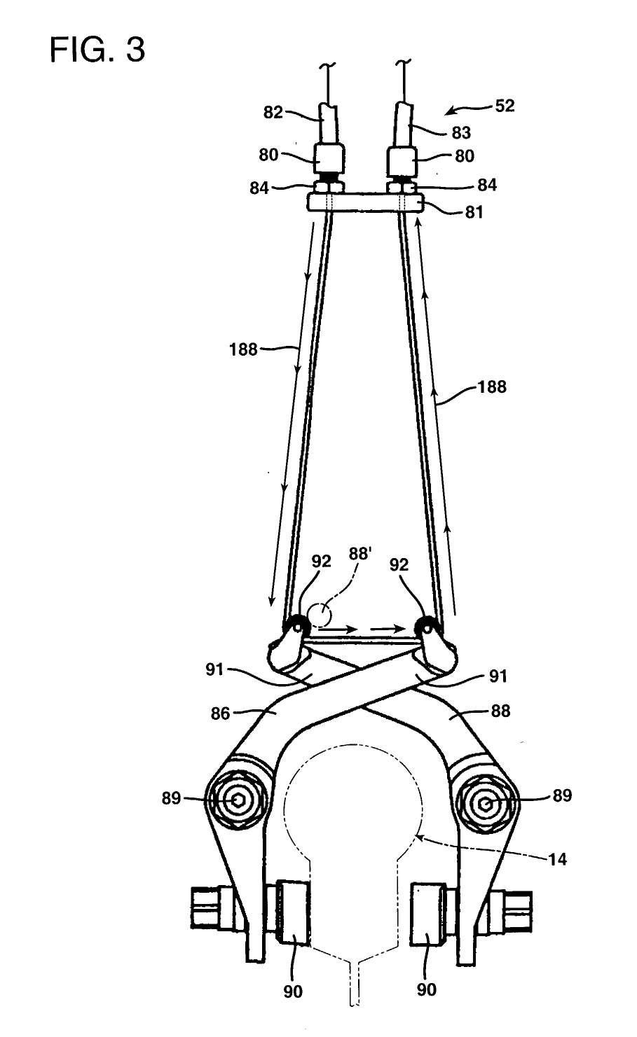

For example, as viewed in FIG. 3, if the force applied to the lever arm end 91 of the brake caliper 86 is initially greater than the force applied to the lever arm end 91 of the brake caliper 88, the brake pad 90 of the brake caliper 86 will tend to make contact with the rim of the rear bicycle wheel 14 prior to contact by the brake pad 90 of the caliper 88. However, the absence of a force tending to resist rotation of the brake caliper 88 will cause the brake cable loop 85 to pull the brake caliper 88 to rotate it to a greater extent, for example, to the position indicated at 88′ in FIG. 3. As a result, the lever arm end 91 of the brake caliper 88 is drawn closer to the stop bar 81 than the lever arm 91 of the brake caliper 86.

Since the single cable core loop 85 of the rear brake operating segment 82 is movable relative to the brake lever arm ends 91 by virtue of the presence of the pulleys 92, movement of the pulley 91 of the brake caliper 88 to the position indicated at 88′ will be offset by a longitudinal shifting of the cable loop 85 relative to the pulleys 91 in the direction indicated by the directional arrows 188 in FIG. 3. The tension on the lower cable core 85 of the rear brake operating segment 52 causes the pulleys 91 to rotate independently of each other to equalize force transmitted to the brake calipers 86 and 88. As a consequence, force is equalized at the opposing ends of the single cable core loop 85 of the rear brake cable operating segment 52 to quickly rotate the pulleys 92 attached to the lever arms 91 of both brake calipers 86 and 88 in a counterclockwise direction, as viewed in FIG. 3, so as to draw the brake pad 90 of the brake caliper 88 quickly into contact with the wheel rim of the rear wheel 14 while maintaining an equal force to the knobs 95 and 96. The bicycle brake system of the invention is thereby self-balancing, since the single brake cable loop 85 of the lower operating brake segment 52 passes through floating roller points on the pulleys 92.

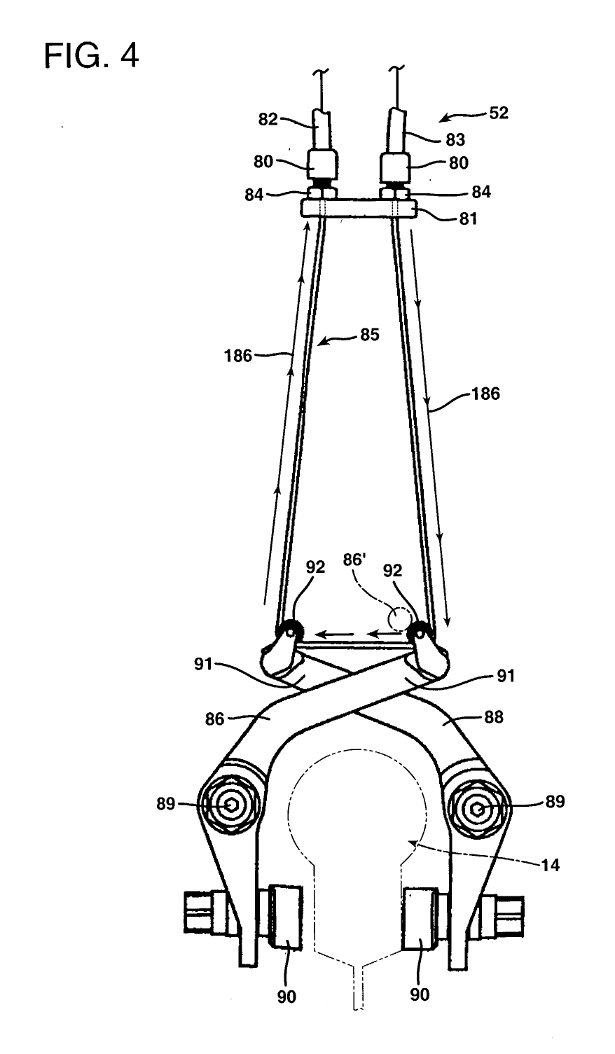

Similarly, if the braking force in unequal in the opposite manner, as illustrated in FIG. 4, the brake cable system of the invention is also self-correcting. That is, for example, if the brake pad 90 of the brake caliper 88 makes contact first with the rim of the rear wheel 14, the brake caliper 88 will momentarily cease to rotate about its brake axle 89, but the brake caliper 86 will continue to rotate in a clockwise direction about its brake axle 89 due to the absence of a resisting force on the brake pad 90 of the brake caliper 86. This results in movement of the lever arm end 91 of the brake caliper 86 to the position indicated at 86′ in FIG. 4. Because of the independent rotation of the pulleys 92, however, the brake cable loop 85 of the rear brake operating segment 52 shifts by traveling over the pulleys 92 in the direction indicated by the directional arrows 186 in FIG. 4. The pulleys 92 at the brake lever arm ends 91 of both brake calipers 86 and 88 will thereupon rotate in a clockwise direction, as viewed in FIG. 4, independently of each other. As a consequence, the “gyro” or cable detangler mechanism 47 always is held in a perpendicular orientation relative to the bicycle head tube 18.

It is to be understood that the self-balancing feature of the bicycle brake system of the invention occurs whatever the reason for an imbalance of forces along the length of the cable loop 85 of the rear brake cable operating segment 52. Such force imbalances can result from a difference in distance of the brake pads 90 from the wheel rim of the rear wheel 14, and also from minor misadjustments of the adjusting nuts 84, flexure in the cable sheaths 82 and 83, and other imbalancing forces. In all such situations the floating force application locations along the single cable loop 85 of the brake cable operating segment 52 passing over the two pulleys 92 equalizes the opposing forces on the opposite sides of the nonrotatable coupling plate 98. The equalization of these forces keeps the “gyro” or detangler mechanism 47 from tilting or “flopping” relative to the head tube 18.

Undoubtedly, numerous variations and modifications of the invention will become readily apparent to those familiar with bicycle brake cable system. For example, while the use of pulleys at the lever arm ends of the brake calipers are preferred, the cable loop 85 could be looped through fixed, nonrotatable guides at the lever arm ends 91 of the brake calipers 86 and 88. Also, various types of “gyro” or cable detangler systems may be utilized in place of the rotatable coupling 47 illustrated and described. Accordingly, the scope of the invention should not be construed as limited to the specific embodiment depicted and described herein, but rather is defined in the claims appended hereto.

I claim:

1. A bicycle brake cable system for operating a pair of opposing bicycle brake calipers from a handlebar-mounted brake lever and including, a rotatable coupling enabling free spinning of a bicycle handlebar and front wheel assembly relative to an associated bicycle frame and including a brake control segment extending between said brake lever and said rotatable coupling, and a brake operating segment extending between said rotatable coupling and said brake calipers, the improvement wherein said brake cable operating segment is comprised of a single, inextensible, lower cable core loop having opposing ends, both of which terminate at said rotatable coupling, and each of said opposing calipers has a cable-engaging lever arm end, and said single lower cable core loop is looped about both of said cable-engaging lever arm ends and is movable relative thereto.

2. A bicycle brake cable system according to claim 1 further comprising separate rollers, one mounted on each of said caliper lever arm ends, whereby said rollers rotate independently of each other to accommodate longitudinal shifting of said lower cable core loop relative thereto.

3. A bicycle brake cable system according to claim 1 further comprising a pair of pulleys, one mounted on each of said caliper lever arm ends, whereby tension on said lower cable core causes said pulleys to rotate independently of each other to equalize force transmitted to said rotatable coupling.

4. In a bicycle brake cable system for operating rear wheel brake calipers on a freestyle bicycle having handlebars, a front wheel steering tube and a front wheel fork mounted together for free spinning rotation relative to a bicycle frame head tube, and including a cable detangler having a nonrotatable collar and a rotatable collar mounted for rotation relative to said nonrotatable collar and said rotatable collar and said nonrotatable collar are longitudinally reciprocal relative to said head tube, the improvement comprising a single, inextensible brake operating cable core loop having opposing ends, both of which are joined to said nonrotatable collar, a separate lever arm on each one of said rear wheel brake calipers, and said brake operating cable core loop is engaged with both said rear wheel brake caliper lever arms for movement in reciprocal, traveling relationship relative thereto.

5. A bicycle brake cable system according to claim 4 further comprising a pulley mounted on each of said lever arms of said rear wheel brake calipers, and said brake operating cable core loop is looped through both of said pulleys.

6. A bicycle brake cable system according to claim 4 further comprising a pulley mounted on each of said lever arms and said brake operating cable core loop passes about both of said pulleys.

7. A bicycle brake cable system according to claim 4 further comprising a pulley mounted on each of said lever arms, and both of said pulleys are engaged by said single brake operating cable core loop.

8. In a bicycle brake cable system for a rear wheel mounted within a rear wheel fork of a bicycle in which said bicycle has handlebars, a handlebar mounting stem, a steering tube, and a front wheel fork all mounted for free spinning rotation relative to a bicycle frame head tube, and employing a cable detangler mechanism between said steering tube and said head tube and a pair of cooperating rear brake calipers having lever arm ends and opposite brake pad ends carrying brake pads thereon mounted on said rear wheel fork to apply braking force against said rear wheel, the improvement comprising a single, inextensible, brake operating cable core having opposing ends, both of which terminate at said cable detangler mechanism, and said brake operating cable core is formed into a single loop that is engaged at floating contact locations with both of said lever arm ends of said pair of cooperating rear brake calipers.

9. A bicycle brake cable system according to claim 8 further comprising a separate pulley on each of said lever arm ends and said single brake operating cable core loop is passed about both of said pulleys which rotate independently of each other in response to movement of said floating contact locations of said loop.

10. A bicycle brake cable system according to claim 8 further comprising separate pulleys on each of said lever arm ends.
